(19) United States
(12) Patent Application Publication
(10) Pub. No.: US 2023/0237127 A1
(43) Pub. Date: Jul. 27, 2023

(54) INTELLIGENT ADAPTION FOR ENGINEERED PREDICTION MODEL FOR A MODEL-BASED SYSTEM UPGRADE

(71) Applicant: Accenture Global Solutions Limited, Dublin 4 (IE)

(72) Inventors: Sarang Padmakar Joshi, Pune (IN); Shubhyant Nigam, Pune (IN)

(21) Appl. No.: 17/586,758

(22) Filed: Jan. 27, 2022

(51) Int. Cl. G06K 9/62; G06N 20/00

(52) U.S. Cl. CPC G06K 9/6262; G06N 20/00

(57) ABSTRACT

Aspects of the present disclosure provide systems, methods, and computer-readable storage media that support mechanisms for enabling upgrading of an existing machine (ML) model-based system to an upgraded ML model-based system using an intelligent adaptive algorithm over a previously trained ML model, while maintaining a level of prediction accuracy from the previously trained ML model. In aspects, the intelligent adaptive algorithm is implemented as an adaptive layer over the previously trained ML model, and provides a mechanism to leverage the previously trained ML model to allow the upgraded ML model-based system to perform operations using data from the upgraded ML model-based system and taking advantage of the accuracy of the previously trained ML model. As such, the intelligent adaptive algorithm retains the previously trained information, and makes predictions using new data from the upgraded ML model-based system without having to retrain the previously trained ML model with the new data.

### TECHNICAL FIELD

The present disclosure relates generally to intelligent adaptive algorithms to adapt a machine learning (ML) model to an upgraded ML model-based system.

### BACKGROUND

In retail, a point of sale (POS) program may be a very useful piece of software that may allow a store to handle a great number of transactions occurring at retail point of sale. In addition, a POS program may be useful in performing other retail operations, such as inventory management. Inventory management in a retail environment is very important, as a customer looking for an out of stock item may cause the customer to be unhappy. In addition, a lack of an efficient inventory management may lead to a store being unable to address spikes in demand (e.g., not having items when a customer is looking for them in a particular day/week) and/or drops in demand (e.g., maintaining items that are not being sought by customer, which may take space and may have storage cost associated with them). A POS program may allow a store to perform inventory management. However, early iterations of POS programs presented several challenges. For example, a great portion of the data entered into a POS program was entered manually, which, depending on size of the retail operation, could be a great burden. Also, early POS programs may not consistently identify correct trends, and were prone to functional errors.

In order to address the recurring issues and errors encountered in early POS systems, the systems were enhanced to use machine learning (ML) models in their operations. One example of a very popular POS system developed to use ML models is the Micros POS system developed by Oracle. In these implementations, an ML model is developed, trained, and stabilized over time in order to perform operations related to various aspects of retail operations. For example, a POS ML model may be configured to inventory needs, as described above, as well as to predict anomalies in retail operations, highlight customers that are likely to be dissatisfied. However, the development, training, and stabilization of the ML model to be implemented into a POS system may take years, but allows the efficiency in performance (e.g., efficiency and accuracy of recommendations) of the system to be very high. In this particular example, a set of training and testing data was curated, in many cases manually. Various ML models were then evaluated and compared to determine and select the most optimal ML model based on the training and testing data. For example, attributes and/or parameters were selected for the training and testing data. The data was then applied to each ML model candidate and, based on the outcome of each ML model for the selected attributes, the ML model with the most effective/optimal outcome was selected. The selected ML model was then integrated into the POS system.

However, recently, newer POS systems have been developed. Therefore, replacing an earlier POS system with a newer POS system is common. For example, a newer POS system is the xStore POS system (also developed by Oracle). The xStore POS system offers advantages over the earlier Micros POS system, which is why it is common for stores to replace the older Micros POS system with the newer xStore POS system. However, it is the case that any ML model that was developed, trained, and stabilized for the older POS systems may become somewhat invalid and the performance may be less efficient (e.g., recommendations and forecasts may not be as accurate) when used with the newer POS systems than when used in the older POS systems. This may be because newer POS systems may have different data structures, may use new attributes, feeds, and/or influencing factors in their decisions and/or recommendations. In these cases, retraining an ML model to operate with a newer POS system may not be immediately possible, as retraining the ML model to operate with the newer POS system may require collection of data from the newer POS system, which may take a while as new data may be collected in the newer POS system little by little, day by day. As a result, the prediction accuracy of the older ML model may be very low when used with the newer POS system. Therefore, upgrading an older POS system to a newer POS system may present a difficult challenge and may adversely affect retail operations.

### SUMMARY

Aspects of the present disclosure provide systems, methods, apparatus, and computer-readable storage media that support mechanisms for enabling upgrading of an existing machine (ML) model-based system to an upgraded ML model-based system using an intelligent adaptive algorithm over a previously trained ML model, while maintaining a level of prediction accuracy from the previously trained ML model. In aspects, the intelligent adaptive algorithm is implemented as an adaptive layer over the previously trained ML model, and provides a mechanism to leverage the previously trained ML model to allow the upgraded ML model-based system to perform operations using data from the upgraded ML model-based system and taking advantage of the accuracy of the previously trained ML model. As such, the intelligent adaptive algorithm retains the previously trained information, and makes predictions using new data from the upgraded ML model-based system without having to retrain the previously trained ML model with the new data.

In a particular aspect, a method for intelligently adapting an ML model to an upgraded ML model-based system includes obtaining, for each domain of a plurality of domains, a correlation score for one or more key features between the upgraded ML model-based system and an existing ML model-based system. In aspects, the one or more key features are related to an influencing factor influencing a prediction result by the ML model. The method further includes generating, based, at least in part, on the correlation score for the one or more key features, an extended set of features. In aspects, the extended set of features includes one or more shadow features corresponding, respectively, to one or more original features that are present in the upgraded ML model-based system and are absent in the existing ML model-based system. The method also includes evaluating a prediction accuracy of the ML model using each features of the extended set of features to identify best performing features of the extended set of features. In aspects, identifying best performing features may include comparing the prediction accuracy of the ML model using a shadow feature of the one or more shadow features with the prediction accuracy of the ML model using an original feature corresponding to the shadow feature, selecting the shadow feature as a best performing feature and rejecting the original feature corresponding to the shadow feature when the prediction accuracy of the ML model using the shadow feature is higher than the prediction accuracy of the ML model using the original feature corresponding to the shadow feature, and selecting the original feature corresponding to the shadow feature as the best performing feature and rejecting the shadow feature when the prediction accuracy of the ML model using the shadow feature is not higher than the prediction accuracy of the ML model using the original feature corresponding to the shadow feature. The method further includes updating the ML model to use the best performing features, and applying the updated ML model to data of the upgraded ML model-based system to obtain the prediction result, the prediction result having an accuracy level at least the same as predictions performed by the ML model for the existing ML model-based system.

In another particular aspect, a system for intelligently adapting an ML model to an upgraded ML model-based system includes a memory and one or more processors communicatively coupled to the memory. The one or more processors are configured to obtain, for each domain of a plurality of domains, a correlation score for one or more key features between the upgraded ML model-based system and an existing ML model-based system. In aspects, the one or more key features are related to an influencing factor influencing a prediction result by the ML model. The one or more processors are further configured to generate, based, at least in part, on the correlation score for the one or more key features, an extended set of features. In aspects, the extended set of features includes one or more shadow features corresponding, respectively, to one or more original features that are present in the upgraded ML model-based system and are absent in the existing ML model-based system. The one or more processors are also configured to evaluate a prediction accuracy of the ML model using each feature of the extended set of features to identify best performing features of the extended set of features. In aspects, identifying best performing features may include comparing the prediction accuracy of the ML model using a shadow feature of the one or more shadow features with the prediction accuracy of the ML model using an original feature corresponding to the shadow feature, selecting the shadow feature as a best performing feature and rejecting the original feature corresponding to the shadow feature when the prediction accuracy of the ML model using the shadow feature is higher than the prediction accuracy of the ML model using the original feature corresponding to the shadow feature, and selecting the original feature corresponding to the shadow feature as the best performing feature and rejecting the shadow feature when the prediction accuracy of the ML model using the shadow feature is not higher than the prediction accuracy of the ML model using the original feature corresponding to the shadow feature. The one or more processors are further configured to update the ML model to use the best performing features, and to apply the updated ML model to data of the upgraded ML model-based system to obtain the prediction result, the prediction result having an accuracy level at least the same as predictions performed by the ML model for the existing ML model-based system.

In another particular aspect, a non-transitory computer-readable storage medium stores instructions that, when executed by one or more processors, cause the one or more processors to perform operations for intelligently adapting an ML model to an upgraded ML model-based system. The operations include obtaining, for each domain of a plurality of domains, a correlation score for one or more key features between the upgraded ML model-based system and an existing ML model-based system. In aspects, the one or more key features are related to an influencing factor influencing a prediction result by the ML model. The operations further include generating, based, at least in part, on the correlation score for the one or more key features, an extended set of features. In aspects, the extended set of features includes one or more shadow features corresponding, respectively, to one or more original features that are present in the upgraded ML model-based system and are absent in the existing ML model-based system. The operations also include evaluating a prediction accuracy of the ML model using each features of the extended set of features to identify best performing features of the extended set of features. In aspects, identifying best performing features may include comparing the prediction accuracy of the ML model using a shadow feature of the one or more shadow features with the prediction accuracy of the ML model using an original feature corresponding to the shadow feature, selecting the shadow feature as a best performing feature and rejecting the original feature corresponding to the shadow feature when the prediction accuracy of the ML model using the shadow feature is higher than the prediction accuracy of the ML model using the original feature corresponding to the shadow feature, and selecting the original feature corresponding to the shadow feature as the best performing feature and rejecting the shadow feature when the prediction accuracy of the ML model using the shadow feature is not higher than the prediction accuracy of the ML model using the original feature corresponding to the shadow feature. The operations further include updating the ML model to use the best performing features, and applying the updated ML model to data of the upgraded ML model-based system to obtain the prediction result, the prediction result having an accuracy level at least the same as predictions performed by the ML model for the existing ML model-based system.

The foregoing has outlined rather broadly the features and technical advantages of the present disclosure in order that the detailed description that follows may be better understood. Additional features and advantages will be described hereinafter which form the subject of the claims of the disclosure. It should be appreciated by those skilled in the art that the conception and specific aspects disclosed may be readily utilized as a basis for modifying or designing other structures for carrying out the same purposes of the present disclosure. It should also be realized by those skilled in the art that such equivalent constructions do not depart from the scope of the disclosure as set forth in the appended claims. The novel features which are disclosed herein, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a block diagram of an example of a system that supports mechanisms for enabling upgrading of an existing machine learning (ML) model-based system to an upgraded ML model-based system using an intelligent adaptive algorithm over a previously trained ML model, while maintaining an acceptable level of prediction accuracy from the previously trained ML model according to one or more aspects;

FIGS. 2A-2C illustrate examples of correlation results for various attributes between an existing ML model-based system and an upgraded ML model-based system for various domains according to one or more aspects;

FIG. 3 shows a block diagram illustrating an example of an intelligent adaptive algorithm implemented according to one or more aspects; and

FIG. 4 is a high level flow diagram of operation of a system configured in accordance with aspects of the present disclosure for providing mechanisms for enabling upgrading of an existing ML model-based system to an upgraded ML model-based system using an intelligent adaptive algorithm over a previously trained ML model, while maintaining an acceptable level of prediction accuracy from the previously trained ML model.

It should be understood that the drawings are not necessarily to scale and that the disclosed aspects are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular aspects illustrated herein.

### DETAILED DESCRIPTION

Aspects of the present disclosure provide systems, methods, apparatus, and computer-readable storage media that provide mechanisms for enabling upgrading of an existing ML model-based system to an upgraded ML model-based system using an intelligent adaptive algorithm over a previously trained ML model, while maintaining an acceptable level of prediction accuracy from the previously trained ML model. In aspects, the intelligent adaptive algorithm is implemented as an adaptive layer over the upgraded ML model-based system that is configured to provide a mechanism to leverage the previously trained ML model (e.g., the trained ML model implemented in the existing ML model-based system) in order to allow the upgraded ML model-based system to perform operations (e.g., make predictions associated with operations such as retail operations) using data from the upgraded ML model-based system and taking advantage of the accuracy of the previously trained ML model. In this manner, the intelligent adaptive algorithm of aspects may retain the previously trained information associated with the previously trained ML model, and may make predictions using new data from the upgraded ML model-based system without having to retrain the previously trained ML model with the new data.

In aspects, the intelligent adaptive algorithm may be configured to correlate attributes of the upgraded ML model-based system and the existing ML model-based system for each of a plurality of domains (e.g., retail domains). The correlation analysis may provide insight into the attributes of the upgraded ML model-based system influencing a prediction. The intelligent adaptive algorithm may use the correlation analysis to extract these upgraded ML model-based system attributes influencing a prediction (e.g., based on the correlation results for each domain, which may indicate the relevancy of a particular attribute to the influencing factor) in order to generate shadow features (e.g., features from the existing ML model-based system that are absent from the upgraded ML model-based system) for each domain, and to identify missing features from the existing ML model-based system that are present in the upgraded ML model-based system. The generate shadow feature and the identified missing features may be merged with the existing features of the existing ML model-based system to generate an extended feature set.

In aspects, the previously trained model may then be evaluated based on the extended data set in order to identify the best performing features from the extended feature set. For example, at each iteration, a feature from the extended set may be evaluated to determine whether the previously trained model performs better (e.g., with a higher accuracy) using the original feature (e.g., the feature present in the existing ML model-based system) or the shadow feature (e.g., the shadow feature generated for the feature present in the existing ML model-based system absent from the upgraded ML model-based system based on the correlation results of the feature). When the previously trained model performs better using the original feature, then the original feature may be selected and the previously trained model may be updated to use the original feature in performing a prediction for the new data. On the other hand, the previously trained model performs better using the shadow feature, then the shadow feature may be selected and the previously trained model may be updated to use the shadow feature in performing a prediction for the new data. In this manner, at least the same prediction accuracy of the previously trained model is maintained, as a shadow feature is selected only if the shadow feature performs better than the original feature.

It is noted that the description that follows is focused on a particular use case for the ML model-based of aspects, namely a POS system. However, this is merely for illustrative purposes and not intended to be limiting in any way. Indeed, the techniques disclosed herein may be applicable when upgrading any system that uses a trained ML model to a new system, and may allow the upgraded system to operate and leverage the trained ML model (e.g., the accuracy obtained from the development and training of the trained ML model over time) during the upgrade.

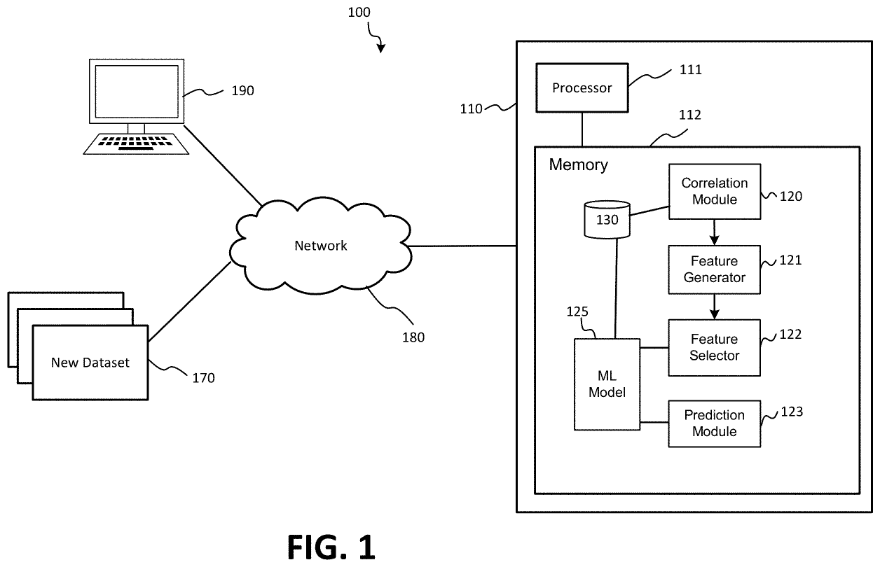

Referring to FIG. 1, an example of a system that supports mechanisms for enabling upgrading of an existing ML model-based system to an upgraded ML model-based system using an intelligent adaptive algorithm over a previously trained ML model, while maintaining an acceptable level of prediction accuracy from the previously trained ML model according to one or more aspects is shown as a system 100. As shown in FIG. 1, system 100 includes server 110, new datasets 170, and at least one user terminal 190. These components, and their individual components, may cooperatively operate to provide functionality in accordance with the discussion herein. For example, the functionality of system 100, and components thereof, may implement the intelligent adaptive algorithm of aspects. In aspects, the functionality of system 100 may implement an adaptive layer of an upgraded ML model-based system (e.g., an upgraded POS system, or a POS system being upgraded) that may enable the upgraded ML model-based system to leverage previously trained ML model 125, which may be an ML model that was implemented, trained, and/or stabilized in an existing ML model-based system that is upgraded with upgraded ML model-based system, in order to perform operations (e.g., make predictions associated with operations such as retail operations) using new data (e.g., new datasets 170) without having to retrain previously trained ML model 125 and while maintain the existing accuracy of previously trained ML model 125.

What follows is a more detailed discussion of the functional blocks of system 100 shown in FIG. 1. However, it is noted that the functional blocks, and components thereof, of system 100 of embodiments of the present invention may be implemented using processors, electronic devices, hardware devices, electronic components, logical circuits, memories, software codes, firmware codes, etc., or any combination thereof. For example, one or more functional blocks, or some portion thereof, may be implemented as discrete gate or transistor logic, discrete hardware components, or combinations thereof configured to provide logic for performing the functions described herein. Additionally or alternatively, when implemented in software, one or more of the functional blocks, or some portion thereof, may comprise code segments operable upon a processor to provide logic for performing the functions described herein.

It is also noted that various components of system 100 are illustrated as single and separate components. However, it will be appreciated that each of the various illustrated components may be implemented as a single component (e.g., a single application, server module, etc.), may be functional components of a single component, or the functionality of these various components may be distributed over multiple devices/components. In such aspects, the functionality of each respective component may be aggregated from the functionality of multiple modules residing in a single, or in multiple devices.

It is further noted that functionalities described with reference to each of the different functional blocks of system 100 described herein is provided for purposes of illustration, rather than by way of limitation and that functionalities described as being provided by different functional blocks may be combined into a single component or may be provided via computing resources disposed in a cloud-based environment accessible over a network.

User terminal 190 may be implemented as a mobile device, a smartphone, a tablet computing device, a personal computing device, a laptop computing device, a desktop computing device, a computer system of a vehicle, a personal digital assistant (PDA), a smart watch, another type of wired and/or wireless computing device, or any part thereof. User terminal 190 may be configured to provide a GUI structured to facilitate input and output operations in accordance with aspects of the present disclosure. Input and output operations may include operations for initiating retail operations, for requesting and/or outputting retail operations predictions (e.g., inventory management predictions, etc.), etc.

Server 110, user terminal 190, and new datasets 170 may be communicatively coupled via network 180. Network 180 may include a wired network, a wireless communication network, a cellular network, a cable transmission system, a Local Area Network (LAN), a Wireless LAN (WLAN), a Metropolitan Area Network (MAN), a Wide Area Network (WAN), the Internet, the Public Switched Telephone Network (PSTN), etc., that may be configured to facilitate communications between server 110, user terminal 190, and new datasets 170.

Server 110 may be configured to receive new datasets 170, and to generate predictions based on the received data, by intelligently applying previously trained ML model 125 through the adaptive layer provided by the functionality of system 100. This functionality of server 110 may be provided by the cooperative operation of the various components of server 110, as will be described in more detail below. Although FIG. 1 shows a single server 110, it will be appreciated that server 110 and its individual functional blocks may be implemented as a single device or may be distributed over multiple devices having their own processing resources, whose aggregate functionality may be configured to perform operations in accordance with the present disclosure.

It is also noted that the various components of server 110 are illustrated as single and separate components in FIG. 1. However, it will be appreciated that each of the various components of server 110 may be a single component (e.g., a single application, server module, etc.), may be functional components of a same component, or the functionality may be distributed over multiple devices/components. In such aspects, the functionality of each respective component may be aggregated from the functionality of multiple modules residing in a single, or in multiple devices.

As shown in FIG. 1, server 110 includes processor 111 and memory 112. Processor 111 may comprise a processor, a microprocessor, a controller, a microcontroller, a plurality of microprocessors, an application-specific integrated circuit (ASIC), an application-specific standard product (ASSP), or any combination thereof, and may be configured to execute instructions to perform operations in accordance with the disclosure herein. In some aspects, as noted above, implementations of processor 111 may comprise code segments (e.g., software, firmware, and/or hardware logic) executable in hardware, such as a processor, to perform the tasks and functions described herein. In yet other aspects, processor 111 may be implemented as a combination of hardware and software. Processor 111 may be communicatively coupled to memory 112.

As shown in FIG. 1, memory 112 includes correlation module 120, feature generator 121, feature selector 122, prediction module 123, previously trained ML model 125, and database 130. Memory 112 may comprise one or more semiconductor memory devices, read only memory (ROM) devices, random access memory (RAM) devices, one or more hard disk drives (HDDs), flash memory devices, solid state drives (SSDs), erasable ROM (EROM), compact disk ROM (CD-ROM), optical disks, other devices configured to store data in a persistent or non-persistent state, network memory, cloud memory, local memory, or a combination of different memory devices. Memory 112 may comprise a processor readable medium configured to store one or more instruction sets (e.g., software, firmware, etc.) which, when executed by a processor (e.g., one or more processors of processor 111), perform tasks and functions as described herein.

Memory 112 may comprise database 130 for storing various information related to operations of system 100. For example, database 130 may store information related to the existing ML model-based system being upgraded, such as configuration, data structures, features of the existing ML model-based system used by previously trained ML model 125 to perform operations for the existing ML model-based system (e.g., predictions), a list of domains to be correlated, user profiles for accessing information and/or reports, etc., which system 100 may use to provide the features discussed herein. Database 130 is illustrated as integrated into memory 112, but may be provided as a separate storage module. Additionally or alternatively, database 130 may be a single database, or may be a distributed database implemented over a plurality of database modules

As noted above, previously trained ML model 125 may represent one or more ML-based models that were previously developed, implemented, trained, and/or stabilized in the existing ML model-based system being upgraded. For example, previously trained ML model 125 may be an ML model that was implemented in an older POS system that is being upgraded to a new POS system over which the adaptive layer provided by the intelligent adaptive algorithm implemented by the functionality of system 100 may be implemented. In aspects, previously trained ML model 125 may be an ML model that was trained and stabilized over many years of operations, and may be capable of operating at a high level of performance, efficiency, and/or accuracy. For example, previously trained ML model 125 may be able to make predictions, based on input data, at a high level of accuracy (e.g., over 90% accurate). For example, previously trained ML model 125 may be used to make retail predictions with respect to inventory requirements. In aspects, previously trained ML model 125 may be any one or more of a number of ML models (e.g., a decision tree, a random forest classifier, a linear regression model, a logistic regression model, etc.). In some aspects, previously trained ML model 125 may be a random forest classifier selected based on previous testing and determined to yield the most accurate results.

Correlation module 120 may be configured to perform an intelligent correlation between the upgraded ML model-based system and the existing ML model-based system. In particular, correlation module 120 may perform a correlation of attributes that are influencing a prediction from the upgraded ML model-based system to the existing ML model-based system, for each of a plurality of domains. For example, in aspects, correlation module 120 may correlate attributes that may have an influence in a prediction to be made by previously trained ML model 125 using new datasets 170. It is noted that new datasets 170 may represent incremental data from the upgraded ML model-based system, and may include data that is structured according to the new configuration of the upgraded ML model-based system. In addition, new datasets 170 may not include sufficient data to train previously trained ML model 125 to make predictions using the data from the upgraded ML model-based system at the same level of accuracy as predictions made using the data in the existing ML model-based system.

In aspects, the intelligent correlation performed by correlation module 120 may include applying a Pearson correlation algorithm or Spearman' s rank correlation algorithm to obtain a correlation, for each of a plurality of domains, for key attributes that are influencing the prediction from the existing ML model-based system to the upgraded ML model-based system. The result of applying the Pearson correlation algorithm or Spearman's rank correlation algorithm may include a correlation score for each correlation, for each domain, from the existing ML model-based system to the upgraded ML model-based system. In aspects, the correlation score for a key attribute may indicate a level of influence of that particular key attribute to the influencing factor, and in this manner may indicate how much the key attribute may influence the prediction. In other words, the correlation score between the existing ML model-based system to the upgraded ML model-based system for a key attribute may indicate whether the key attribute should be included in the generation of the extended feature set, as described below. In aspects, the plurality of domains may include retail domains such as customer account, invoice, customer relationship management, daily reporting, customer work order, discount, inventory, item, location, deal pricing, scheduling, control, security, sales, tax, etc.

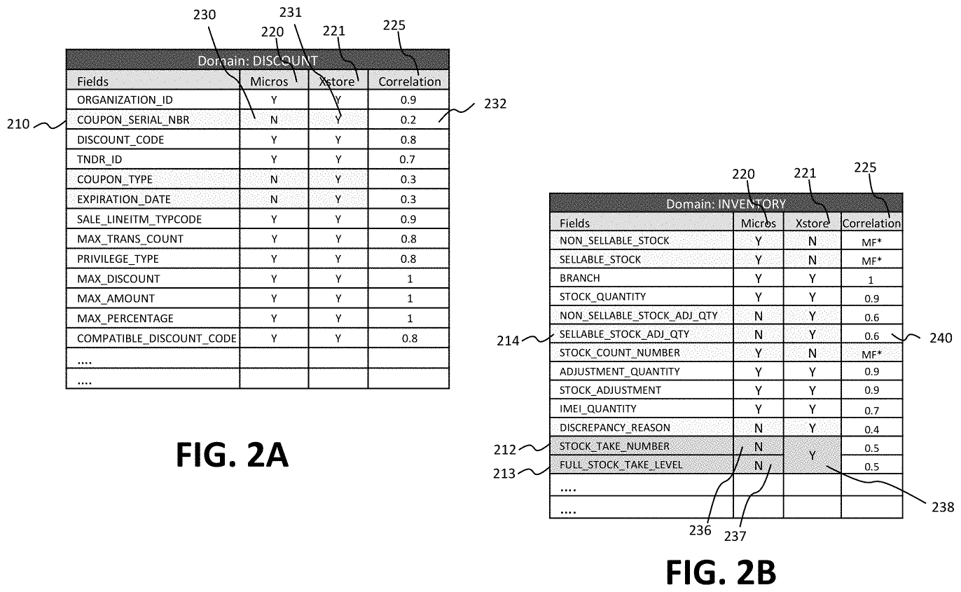

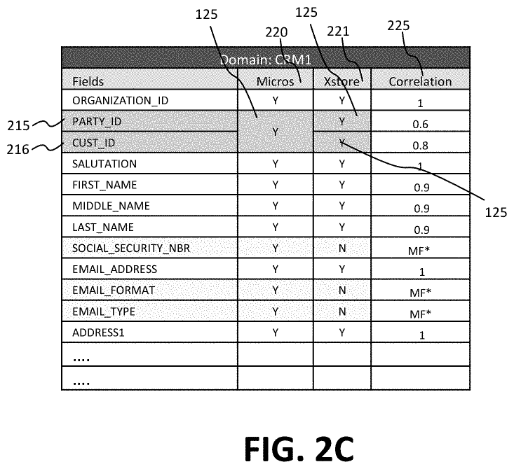

FIGS. 2A-2C illustrate examples of correlation results for various attributes between an existing ML model-based system and an upgraded ML model-based system for various domains in accordance with aspects of the present disclosure. In aspects, correlation module 120 may identify key attributes, for each domain, from the existing ML model-based system that correlate from the existing ML model-based to the upgraded ML model-based system as N:1, where N represents many, as 1:N, as 1:1, as changing attributes, as non-correlated attributes, and/or as negatively correlated attributes. For example, as shown in FIG. 2A, correlation module 120 may generate a correlation (e.g., shown in correlation column 225), for the discount domain, for each key attribute influencing the prediction, from the existing ML model-based system (e.g., Micros POS system 220) to the upgraded ML model-based system (e.g., xStore POS system 221). In this case, for the discount domain, the correlation between each key attribute from Micros POS system 220 to xStore POS system 221 may be a 1:1 correlation, as each attribute may be correlated from a single attribute in Micros POS system 220 to a single attribute in xStore POS system 221. For example, correlation module 120 may determine that key attribute 210 (e.g., COUPON_SERIAL_NBR) is correlated between Micros POS system 220 and xStore POS system 221 in a 1:1 correlation, meaning that the single attribute in Micros POS system 220 correlates to a single attribute in xStore POS system 221.

In another example, as shown in FIG. 2B, correlation module 120 may generate a correlation (e.g., shown in correlation column 225), for the inventory domain, for each key attribute influencing the prediction, from Micros POS system 220 to xStore POS system 221. In this case, for the discount domain, there may be an N:1 correlation between Micros POS system 220 to xStore POS system 221 for some key attributes. For example, a correlation may be found for attributes 212 (e.g., STOCK_TAKE_NUMBER) and 213 (e.g., FULL_STOCK_TAKE_LEVEL) between two attributes in Micros POS system 220 to a single key attribute in xStore POS system 221, which is an N:1 correlation.

In yet another example, as shown in FIG. 2C, correlation module 120 may generate a correlation (e.g., shown in correlation column 225), in this example for the customer relationship management domain, for each key attribute influencing the prediction, from Micros POS system 220 to xStore POS system 221. In this case, for the customer relationship management domain, there may be a 1:N correlation between some key attributes. For example, a correlation may be found between attributes 215 (e.g., PARTY_ID) and 216 (e.g., CUST_ID) from a single attribute in Micros POS system 220 to two key attributes in xStore POS system 221, which is an 1:N correlation.

In some aspects, correlation module 120 may identify attributes that correlate between the existing ML model-based system and the upgraded ML model-based system as continuous changing attributes. For example, some attributes in the inventory domain may be continuous changing attributes. For these attributes, there may be a correlation between the existing ML model-based system to the upgraded ML model-based system. In aspects, correlation module 120 may identify attributes for which there is no correlation between the existing ML model-based system and the upgraded ML model-based system. In aspects, these non-correlated items may be eliminated, deleted, or may be ignored in the generation of the extended feature set as described in more detail below, as this items may have no influence at all in the prediction. In aspects, correlation module 120 may identify attributes for which there is may be a negative correlation between the existing ML model-based system and the upgraded ML model-based system. In some cases, correlation module 120 may assess the impact of these negative-correlated attributes on influencing factors, to determine how these negative-correlated attributes may influence the prediction.

In aspects, as noted above, the correlation score for a key attribute may indicate a level of influence of that particular key attribute to the influencing factor, and in this manner may indicate how much the key attribute may influence the prediction. In aspects, a correlation score that does not exceed 0.3 may indicate a low correlation (e.g., not very correlated), a score higher than 0.3 but not exceeding 0.5 may indicate a medium correlation (e.g., somewhat correlated), and a score higher than 0.5 may indicate a high correlation. For example, as shown in FIG. 2A, key attribute 210 may have a correlation score between Micros POS system 220 and xStore POS system 221 of 0.2, as shown in 232. In aspects, a 0.2 may be a low level of correlation, indicating that the key attribute 210 is less correlated between Micros POS system 220 and xStore POS system 221 for the discount domain. In this manner, this key attribute 210 may not have a very significant influence in the prediction to be made. As a result, key attribute 210 may not be included in the generation of the extended feature set, as described below. On the other hand, as shown in FIG. 2B, key attribute 214 may have a correlation score, for the inventory domain, between Micros POS system 220 and xStore POS system 221 of 0.6, as shown in 240. In aspects, a 0.6 may be a high level of correlation, indicating that key attribute 214 may be highly correlated between Micros POS system 220 and xStore POS system 221 for the inventory domain. In this manner, this key attribute 214 may have a very significant influence in the prediction to be made. As a result, key attribute 214 may be included in the generation of the extended feature set, as described below.

In aspects, the correlation results obtained by correlation module 120 may be used to assign or re-assign a weight of the influencing factors. For example, the correlation results, including the correlation scores as well as the correlation form (e.g., 1:1, N:1, 1:N, no correlation, negative correlation, etc.), may be used to assign or re-assign a weight to the various attributes identified in the correlation analysis. The weight of the various attributes may be used to generate the extended feature set, as will be described below.

With reference back to FIG. 1, feature generator 121 may be configured to generate, based on the correlation results from correlation module 120, an extended feature set including data from the existing ML model-based system enriched with influencing factors from the upgraded ML model-based system. In aspects, enriching the data from the existing ML model-based system with influencing factors from the upgraded ML model-based system may include a targeted extraction of correlated attributes from the upgraded ML model-based system. This may include, creation of shadow features and/or identification of missing features for attributes that are determined to have an influence on the prediction based on the correlation analysis by correlation module 120.

In aspects, feature generator 121 may be configured to generate shadow features for attributes that are determined to have an influence on the prediction. In aspects, a shadow feature may be a feature created for attributes that are not present in the existing ML model-based system but are present in the upgraded ML model-based system. In this case, based on the correlation results, a shadow feature may be created for attributes that are not present in the existing ML model-based system but are present in the upgraded ML model-based system. In aspects, whether or not the shadow feature is created may be based on the correlation score and/or whether the correlation of the attribute missing in existing ML model-based system is an e.g., 1:1, N:1, 1:N, non-correlated, and/or negative correlated attribute. In any case, if feature generator 121 determines, based on the correlation results, to generate or create a shadow feature for a particular attribute, the shadow feature is generated. For example, as shown in FIG. 2A, key attribute 210 may have a correlation score between Micros POS system 220 and xStore POS system 221 of 0.2, as shown in 232, and may be in a 1:1 correlation. In these aspects, based on the correlation results for key attribute 210, it may be found that key attribute 210 may not have a significant influence on the prediction to be made by previously trained ML model 125 based on new datasets 170. Moreover, as shown, key attribute 210 is present in the upgraded ML model-based system xStore POS system 221, as shown in 231, but it is not present in the existing ML model-based system Micros POS system 220, as shown in 230. In this case, feature generator 121 may determine to forego creating a shadow feature for key attribute 210, based on the correlation analysis by correlation module 120.

In another example, however, as shown in FIG. 2B, key attribute 214 may have a correlation score, for the inventory domain, between Micros POS system 220 and xStore POS system 221 of 0.6, as shown in 240, and may be in a 1:1 correlation. In this case, it may be found that key attribute 214 may have a significant influence on the prediction to be made by previously trained ML model 125 based on new datasets 170. Moreover, as shown, key attribute 214 is present in the upgraded ML model-based system xStore POS system 221, but key attribute 214 is not present in the existing ML model-based system Micros POS system 220. In this case, feature generator 121 may determine to create a shadow feature for key attribute 214, based on the correlation analysis by correlation module 120.

In yet another example, key attributes 212 and 213 may have a correlation score, for the inventory domain, between Micros POS system 220 and xStore POS system 221 of 0.5, and may be in an N:1 correlation. In this case, it may be found that key attributes 212 and 213 may have a significant influence on the prediction to be made by previously trained ML model 125 based on new datasets 170. Moreover, as shown, key attributes 212 and 213 may be present in the upgraded ML model-based system xStore POS system 221 as shown in 238, but may not be present in the existing ML model-based system Micros POS system 220 as shown in 236 and 237. In this case, feature generator 121 may determine to create a shadow feature for each of key attributes 212 and 213, based on the correlation analysis by correlation module 120, based on the correlation analysis by correlation module 120.

In aspects, feature generator 121 may be configured to identify attributes that are present in the existing ML model-based system but are not present in the upgraded ML model-based system. In aspects, feature generator 121 may be configured to use nearest neighbor classification algorithms in order to identify attributes in the upgraded ML model-based system that are most closely related to the attributes that are present in the existing ML model-based system but are not present in the upgraded ML model-based system based on the correlation analysis by correlation module 120. In this manner, feature generator 121 may be configured to identify closest correlated features in the existing ML model-based system using the proximity analysis of nearest neighbor classification algorithms. In aspects, whether or not feature generator 121 determines to identify closest correlated features in the existing ML model-based system may be based on the correlation score and/or whether the correlation of the attribute missing in existing ML model-based system is an e.g., 1:1, N:1, 1:N, non-correlated, and/or negative correlated attribute.

In aspects, feature generator 121 may be configured to merge the generated shadow features and the identified closest correlated features with the original features of previously trained ML model 125 to generate an extended features set. For example, previously trained ML model 125 may be originally configured to operate in the existing ML model-based system and may include a set of original features in its configuration. These original set of features may be merged with the generated shadow features and the identified closest correlated features to generate the extended features set. In this manner, the extended features set may include the original features of previously trained ML model 125, as well as the shadow features and the closest correlated features identified by feature generator 121 based on the correlation analysis. The extended features set may represent data from the existing ML model-based system enriched with influencing factors from the upgraded ML model-based system.

With reference back to FIG. 1, feature selector 122 may be configured to evaluate previously trained ML model 125 based on the extended features set. In aspects, evaluating previously trained ML model 125 based on the extended features set may allow feature selector 122 to identify best performing features in the extended features set. For example, at every iteration of an iterative process, feature selector 122 may determine, by applying previously trained ML model 125 to testing data, whether an original feature or a shadow feature created for the original feature performs better. In aspects, better performance may refer to a more accurate prediction. For example, a shadow feature in the extended features set may associated with an original feature (e.g., a feature that is present in the existing ML model-based system but absent from the upgraded ML model-based system). Feature selector 122 may apply previously trained ML model 125 to the testing data using the shadow feature and may obtain a prediction result, which may have a first accuracy. Feature selector 122 may also apply previously trained ML model 125 to the testing data using the corresponding original feature and may obtain a prediction result, which may have a second accuracy. Feature selector 122 may compare the first accuracy of the prediction result obtained by previously trained ML model 125 using the shadow feature and the second accuracy of the prediction result obtained by previously trained ML model 125 using the original feature. Feature selector 122 may confirm the feature with the highest accuracy, and may reject the feature with the lesser accuracy. For example, if the original features yields a higher accuracy result than the shadow feature, the original feature is confirmed and the shadow feature is rejected. On the other hand, if the shadow feature yields a higher accuracy result than the original features, the original feature is rejected and the shadow feature is confirmed. This process may be done for all shadow features in the extended features set, according to the iterative process, such that all features are either confirmed or rejected. In aspects, feature selector 122 may select the confirmed features to update the previously trained ML model 125 with the confirmed features.

In this manner, updating the previously trained ML model 125 with the with the confirmed features allows previously trained ML model 125 to learn, in a far lesser time, how to operate and make predictions based on the new scenarios now available in new datasets 170 from the upgraded ML model-based system without having to retrain previously trained ML model 125 with the data from the upgraded ML model-based system.

Prediction module 123 may be configured to apply the updated previously trained ML model 125 (e.g., updated with the best performing features as determined by feature selector 122) to new datasets 170 (e.g., from the upgraded ML model-based system) in order to perform ML model-based operations for the upgraded ML model-based system. For example, in a POS system, updated previously trained ML model 125 may be applied to new datasets 170 in order to perform a prediction (e.g., inventory management related predictions). In aspects, the results of the ML model-based operations in the upgraded ML model-based system using the updated previously trained ML model 125 may have at least a same level of accuracy as if the ML model-based operations were performed in the existing ML model-based system using the non-updated previously trained ML model 125. In these cases, the at least same level of accuracy may be achieved without having to redevelop, retrain, and/or re-stabilize the previously trained ML model 125 (e.g., using the data from the upgraded ML model-based system, which would take considerable effort and considerable time).

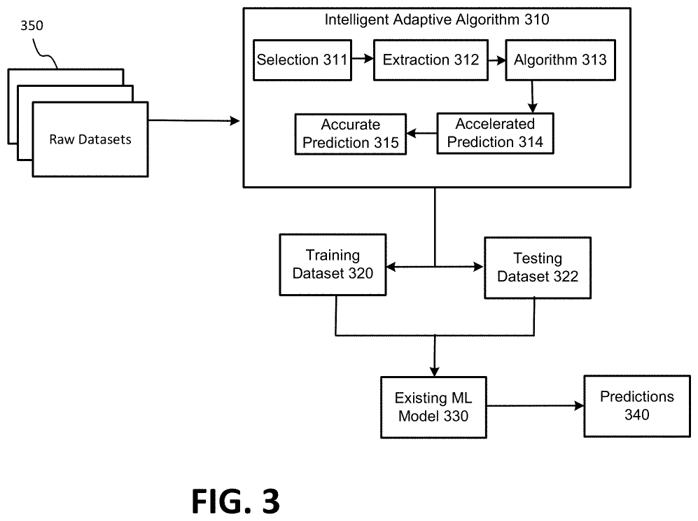

FIG. 3 shows a block diagram illustrating an example of an intelligent adaptive algorithm implemented in accordance with aspects of the present disclosure. In aspects, the intelligent adaptive algorithm illustrated in FIG. 3 may be implemented during an upgrade of an existing ML model-based system to an upgraded ML model-based system, and may be implemented over an existing ML model (e.g., a previously trained ML model), and may enable the upgrade to be performed such that the existing ML model may be used to perform ML model-based operations on the data from the upgraded ML model-based system while maintaining an acceptable level of prediction accuracy from the existing ML model.

In aspects, as shown, raw datasets 350 may be received by intelligent adaptive algorithm 310. Raw datasets 350 may represent data from the upgraded ML model-based system. In aspects, raw datasets 350 may include data structured in accordance with the configuration of the upgraded ML model-based system, and may be structured with the new configuration, new columns (e.g., added or deleted columns), new datatypes, etc.

In aspects, intelligent adaptive algorithm 310 may perform operations to enable existing ML model 330 to be used to perform ML model-based operations on data from the upgraded ML model-based system (e.g., raw datasets 350) while maintaining an acceptable level of prediction accuracy from existing ML model 330. For example, in aspects, intelligent adaptive algorithm 310 may perform selection operations at 311. Selection operations may include performing correlation of attributes from the upgraded ML model-based system and the existing ML model-based system that influence the ML model-based operations performed by existing ML model 330. Functionality for performing correlation may be in accordance with the functionality of correlation module 120 discussed above with respect to FIG. 1.

In aspects, intelligent adaptive algorithm 310 may perform extraction operations at 312. Extraction operations may include performing targeted extraction of correlated attributes from the upgraded ML model-based system. For example, in aspects, extraction operations may include generating an extended features set for features determined to have an influence on the ML model-based operations performed by existing ML model 330, based on correlation operations. Functionality for performing extraction operations may be in accordance with the functionality of feature generator 121 discussed above with respect to FIG. 1.

In aspects, intelligent adaptive algorithm 310 may retain the existing ML model (e.g., existing ML model 330) at 313, such as by evaluating existing ML model 330 using the extended features set to select the best performing features and update existing ML model 330 with the selected features from the extended features set. Functionality for performing operations to retain the existing ML model may be in accordance with the functionality of feature selector 122 discussed above with respect to FIG. 1.

In aspects, intelligent adaptive algorithm 310 may perform accelerated prediction operations at 314. Accelerated prediction operations may include performing prediction operations using the updated existing ML model 330, e.g., updated based on the evaluation of the ML model using the extended features set. In aspects, the prediction operations may be considered accelerated predictions, as the predictions may be made by existing ML model 330 without having to wait to redevelop and retrain existing ML model 330 using data from the upgraded ML model-based system. Functionality for performing accelerated prediction operations may be in accordance with the functionality of prediction module 123 discussed above with respect to FIG. 1.

In aspects, intelligent adaptive algorithm 310 may perform accurate prediction operations at 315. In aspects, the predictions made using the updated existing ML model 330, e.g., updated based on the evaluation of the ML model using the extended features set, may be accurate predictions, which may be at least as accurate as predictions made using existing ML model 330 with data from the existing ML model-based system. Functionality for performing accurate prediction operations may be in accordance with the functionality of prediction module 123 discussed above with respect to FIG. 1.

In aspects, intelligent adaptive algorithm 310 may generate training dataset 320 and testing dataset 322. Training dataset 320 and testing dataset 322 may be datasets configured to be read by existing ML model 330. Existing ML model 330 may be trained using training dataset 320 and testing dataset 322, which may represent data from the existing ML model-based system enriched with influencing factors from the upgraded ML model-based system. Existing Ml model 330 may be used to perform ML model-based operations (e.g., predictions 340) on the data from the upgraded ML model-based system.

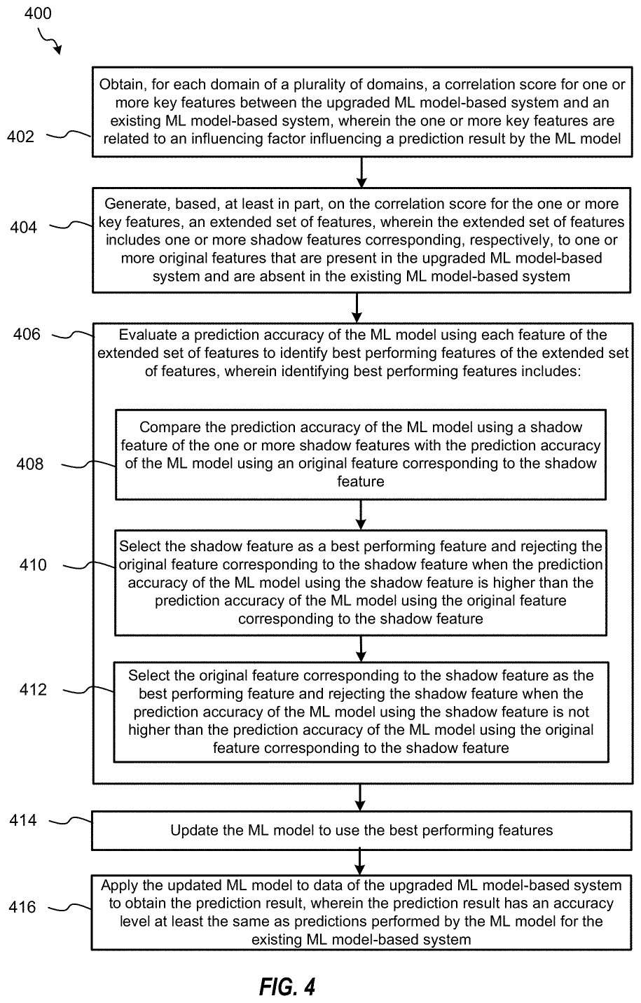

FIG. 4 is a high level flow diagram 400 of operation of a system configured in accordance with aspects of the present disclosure for providing mechanisms for enabling upgrading of an existing ML model-based system to an upgraded ML model-based system using an intelligent adaptive algorithm over a previously trained ML model, while maintaining an acceptable level of prediction accuracy from the previously trained ML model. For example, the functions illustrated in the example blocks shown in FIG. 4 may be performed by system 100 of FIG. 1 according to aspects herein.

The method 400 includes obtaining, for each domain of a plurality of domains, a correlation score for one or more key features between the upgraded ML model-based system and an existing ML model-based system, at 402. In aspects, the one or more key features are related to an influencing factor influencing a prediction result by the ML model. In aspects, the existing ML model-based system is an existing POS retail system that is being upgraded into an upgraded POS retail system, and the upgraded ML model-based system is the upgraded POS retail system.

In aspects, obtaining the correlation score for the one or more key features may also include identifying a correlation of the one or more key features between the existing ML model-based system and the upgraded ML model-based system as a one-to-one correlation, in which a single attribute from the existing ML model-based system correlates to a single attribute of the upgraded ML model-based system, as a one-to-many correlation, in which a single attribute from the existing ML model-based system correlates to a plurality of attributes of the upgraded ML model-based system, as a many-to-one correlation, in which a plurality of attributes from the existing ML model-based system correlates to a single attribute of the upgraded ML model-based system, as a correlation of a continuous changing attribute, as a negative correlation of an attribute between the existing ML model-based system and the upgraded ML model-based system, and/or as a non-correlated attribute between the existing ML model-based system and the upgraded ML model-based system.

The method 400 includes generating, based, at least in part, on the correlation score for the one or more key features, an extended set of features, at 404. In aspects, the extended set of features includes one or more shadow features corresponding, respectively, to one or more original features that are present in the upgraded ML model-based system and are absent in the existing ML model-based system. In aspects, generating the extended set of features may also be based on the identified correlation of the one or more key features between the existing ML model-based system and the upgraded ML model-based system.

In aspects, the extended set of features may also include one or more closest correlated features representing features in the upgraded ML model-based system that are most closely related to attributes that are present in the existing ML model-based system and are absent from the upgraded ML model-based system.

The method 400 includes evaluating a prediction accuracy of the ML model using each feature of the extended set of features to identify best performing features of the extended set of features, at 406. In aspects, identifying best performing features includes comparing the prediction accuracy of the ML model using a shadow feature of the one or more shadow features with the prediction accuracy of the ML model using an original feature corresponding to the shadow feature, at 408. Identifying best performing features may also include selecting the shadow feature as a best performing feature and rejecting the original feature corresponding to the shadow feature when the prediction accuracy of the ML model using the shadow feature is higher than the prediction accuracy of the ML model using the original feature corresponding to the shadow feature, at 410, and selecting the original feature corresponding to the shadow feature as the best performing feature and rejecting the shadow feature when the prediction accuracy of the ML model using the shadow feature is not higher than the prediction accuracy of the ML model using the original feature corresponding to the shadow feature, at 412.

The method 400 includes updating the ML model to use the best performing features, at 414, and applying the updated ML model to data of the upgraded ML model-based system to obtain the prediction result, at 416. In aspects, the prediction result has an accuracy level at least the same as predictions performed by the ML model for the existing ML model-based system.

In aspects, the intelligent adaptive algorithm of aspects may be deployed while predictions of the existing ML model, using only the data from the upgraded ML model-based system, have an accuracy below a predetermined accuracy threshold. Once predictions of the existing ML model, using only the data from the upgraded ML model-based system, have an accuracy above the predetermined accuracy threshold, the intelligent adaptive algorithm, e.g., the adaptive layer over the existing ML model provided by the intelligent adaptive algorithm, may be turned off and the upgraded ML model-based system may employ the existing ML model. In aspects, the predetermined accuracy threshold may be an accuracy equal to the accuracy obtained with the existing ML model when used in the existing system. In other words, while the accuracy of the ML model used in the upgraded ML model-based system is below the accuracy of the ML model as used in the existing ML model-based system, the intelligent adaptive algorithm may be used to ensure that the accuracy of predictions of the ML model as used in the upgraded ML model-based system may be at least the same as the accuracy of the ML model as used in the existing ML model-based system. In aspects, the intelligent adaptive algorithm may be turned back on if a further update to the upgraded ML model-based system is performed that renders the new ML model invalid.

It is noted that other types of devices and functionality may be provided according to aspects of the present disclosure and discussion of specific devices and functionality herein have been provided for purposes of illustration, rather than by way of limitation. It is noted that the operations of the method 400 of FIG. may be performed in any order, or that operations of one method may be performed during performance of another method, including one or more operations of the method 400 of FIG. 4. It is also noted that the method 400 of FIG. 4 may also include other functionality or operations consistent with the description of the operations of the system 100 of FIG. 1.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-4) include processors, electronics devices, hardware devices, electronics components, logical circuits, memories, software codes, firmware codes, among other examples, or any combination thereof. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules, and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. In some implementations, a processor may also be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media can include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, hard disk, solid state disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed aspect, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and processes described in the specification. As one of ordinary skill in the art will readily appreciate from the present disclosure, processes, machines, manufacture, compositions of matter, means, methods, or operations, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or operations.

What is claimed is:

1. A method for intelligently adapting a machine learning (ML) model to an upgraded ML model-based system, the method comprising:
obtaining, for each domain of a plurality of domains, a correlation score for one or more key features between the upgraded ML model-based system and an existing ML model-based system, wherein the one or more key features are related to an influencing factor influencing a prediction result by the ML model;
generating, based, at least in part, on the correlation score for the one or more key features, an extended set of features, wherein the extended set of features includes one or more shadow features corresponding, respectively, to one or more original features that are present in the upgraded ML model-based system and are absent in the existing ML model-based system;
evaluating a prediction accuracy of the ML model using each features of the extended set of features to identify best performing features of the extended set of features, wherein identifying best performing features includes:
comparing the prediction accuracy of the ML model using a shadow feature of the one or more shadow features with the prediction accuracy of the ML model using an original feature corresponding to the shadow feature;
selecting the shadow feature as a best performing feature and rejecting the original feature corresponding to the shadow feature when the prediction accuracy of the ML model using the shadow feature is higher than the prediction accuracy of the ML model using the original feature corresponding to the shadow feature; and
selecting the original feature corresponding to the shadow feature as the best performing feature and rejecting the shadow feature when the prediction accuracy of the ML model using the shadow feature is not higher than the prediction accuracy of the ML model using the original feature corresponding to the shadow feature;
updating the ML model to use the best performing features; and
applying the updated ML model to data of the upgraded ML model-based system to obtain the prediction result, wherein the prediction result has an accuracy level at least the same as predictions performed by the ML model for the existing ML model-based system.

2. The method of claim 1, wherein the existing ML model-based system is an existing point of sale (POS) retail system that is being upgraded into an upgraded POS retail system, and wherein the upgraded ML model-based system is the upgraded POS retail system.

3. The method of claim 1, wherein obtaining the correlation score for the one or more key features further includes identifying a correlation of the one or more key features between the existing ML model-based system and the upgraded ML model-based system as one or more of:
a one-to-one correlation, wherein a single attribute from the existing ML model-based system correlates to a single attribute of the upgraded ML model-based system;
a one-to-many correlation, wherein a single attribute from the existing ML model-based system correlates to a plurality of attributes of the upgraded ML model-based system;
a many-to-one correlation, wherein a plurality of attributes from the existing ML model-based system correlates to a single attribute of the upgraded ML model-based system;
a correlation of a continuous changing attribute;
a negative correlation of an attribute between the existing ML model-based system and the upgraded ML model-based system; or
a non-correlated attribute between the existing ML model-based system and the upgraded ML model-based system.

4. The method of claim 3, wherein generating the extended set of features is further based on the identified correlation of the one or more key features between the existing ML model-based system and the upgraded ML model-based system.

5. The method of claim 1, wherein the plurality of domains includes one or more of:
a customer account domain;
an invoice domain;
a customer relationship management domain;
a daily reporting domain;
a customer work order domain;
a discount domain;
an inventory domain;
an item domain;
a location domain;
a deal pricing domain;
a scheduling domain;
a control domain;
a security domain;
a sales domain; or
a tax domain.

6. The method of claim 1, wherein the correlation score for the one or more key features indicates a level of influence of the one or more key features on the prediction result by the ML model for a respective domain.

7. The method of claim 1, wherein the extended set of features further includes one or more closest correlated features, the closest correlated features representing features in the upgraded ML model-based system that are most closely related to attributes that are present in the existing ML model-based system and are absent from the upgraded ML model-based system.

8. The method of claim 7, further comprising:
identifying, based on proximity analysis using a nearest classification algorithm, the closest correlated features; and
determining, based, at least in part, on the correlation score for the one or more key features, whether to include the closest correlated features in the extended set of features.

9. A system for intelligently adapting a machine learning (ML) model to an upgraded ML model-based system, the system comprising:
a memory; and
one or more processors communicatively coupled to the memory, the one or more processors configured to:
obtain, for each domain of a plurality of domains, a correlation score for one or more key features between the upgraded ML model-based system and an existing ML model-based system, wherein the one or more key features are related to an influencing factor influencing a prediction result by the ML model;
generate, based, at least in part, on the correlation score for the one or more key features, an extended set of features, wherein the extended set of features includes one or more shadow features corresponding, respectively, to one or more original features that are present in the upgraded ML model-based system and are absent in the existing ML model-based system;
evaluate a prediction accuracy of the ML model using each features of the extended set of features to identify best performing features of the extended set of features, wherein identifying best performing features includes:
comparing the prediction accuracy of the ML model using a shadow feature of the one or more shadow features with the prediction accuracy of the ML model using an original feature corresponding to the shadow feature;
selecting the shadow feature as a best performing feature and rejecting the original feature corresponding to the shadow feature when the prediction accuracy of the ML model using the shadow feature is higher than the prediction accuracy of the ML model using the original feature corresponding to the shadow feature; and
selecting the original feature corresponding to the shadow feature as the best performing feature and rejecting the shadow feature when the prediction accuracy of the ML model using the shadow feature is not higher than the prediction accuracy of the ML model using the original feature corresponding to the shadow feature;
update the ML model to use the best performing features; and
apply the updated ML model to data of the upgraded ML model-based system to obtain the prediction result, wherein the prediction result has an accuracy level at least the same as predictions performed by the ML model for the existing ML model-based system.

10. The system of claim 9, wherein the existing ML model-based system is an existing point of sale (POS) retail system that is being upgraded into an upgraded POS retail system, and wherein the upgraded ML model-based system is the upgraded POS retail system.

11. The system of claim 9, wherein the configuration of the one or more processors to obtain the correlation score for the one or more key features further includes configuration of the one or more processors to identify a correlation of the one or more key features between the existing ML model-based system and the upgraded ML model-based system as one or more of:
a one-to-one correlation, wherein a single attribute from the existing ML model-based system correlates to a single attribute of the upgraded ML model-based system;
a one-to-many correlation, wherein a single attribute from the existing ML model-based system correlates to a plurality of attributes of the upgraded ML model-based system;
a many-to-one correlation, wherein a plurality of attributes from the existing ML model-based system correlates to a single attribute of the upgraded ML model-based system;
a correlation of a continuous changing attribute;
a negative correlation of an attribute between the existing ML model-based system and the upgraded ML model-based system; or
a non-correlated attribute between the existing ML model-based system and the upgraded ML model-based system.

12. The system of claim 11, wherein generating the extended set of features is further based on the identified correlation of the one or more key features between the existing ML model-based system and the upgraded ML model-based system.

13. The system of claim 9, wherein the plurality of domains includes one or more of:
a customer account domain;
an invoice domain;
a customer relationship management domain;
a daily reporting domain;
a customer work order domain;
a discount domain;
an inventory domain;
an item domain;
a location domain;
a deal pricing domain;
a scheduling domain;
a control domain;
a security domain;
a sales domain; or
a tax domain.

14. The system of claim 9, wherein the correlation score for the one or more key features indicates a level of influence of the one or more key features on the prediction result by the ML model for a respective domain.

15. The system of claim 9, wherein the extended set of features further includes one or more closest correlated features, the closest correlated features representing features in the upgraded ML model-based system that are most closely related to attributes that are present in the existing ML model-based system and are absent from the upgraded ML model-based system.

16. The system of claim 15, wherein the one or more processors are further configured to:
identify, based on proximity analysis using a nearest classification algorithm, the closest correlated features; and
determine, based, at least in part, on the correlation score for the one or more key features, whether to include the closest correlated features in the extended set of features.

17. A non-transitory computer-readable storage medium storing instructions that, when executed by one or more processors, cause the one or more processors to perform operations for intelligently adapting a machine learning (ML) model to an upgraded ML model-based system, the operations comprising:
obtaining, for each domain of a plurality of domains, a correlation score for one or more key features between the upgraded ML model-based system and an existing ML model-based system, wherein the one or more key features are related to an influencing factor influencing a prediction result by the ML model;
generating, based, at least in part, on the correlation score for the one or more key features, an extended set of features, wherein the extended set of features includes one or more shadow features corresponding, respectively, to one or more original features that are present in the upgraded ML model-based system and are absent in the existing ML model-based system;
evaluating a prediction accuracy of the ML model using each features of the extended set of features to identify best performing features of the extended set of features, wherein identifying best performing features includes:
comparing the prediction accuracy of the ML model using a shadow feature of the one or more shadow features with the prediction accuracy of the ML model using an original feature corresponding to the shadow feature;
selecting the shadow feature as a best performing feature and rejecting the original feature corresponding to the shadow feature when the prediction accuracy of the ML model using the shadow feature is higher than the prediction accuracy of the ML model using the original feature corresponding to the shadow feature; and
selecting the original feature corresponding to the shadow feature as the best performing feature and rejecting the shadow feature when the prediction accuracy of the ML model using the shadow feature is not higher than the prediction accuracy of the ML model using the original feature corresponding to the shadow feature;
updating the ML model to use the best performing features; and
applying the updated ML model to data of the upgraded ML model-based system to obtain the prediction result, wherein the prediction result has an accuracy level at least the same as predictions performed by the ML model for the existing ML model-based system.

18. The non-transitory computer-readable storage medium of claim 17, wherein obtaining the correlation score for the one or more key features further includes identifying a correlation of the one or more key features between the existing ML model-based system and the upgraded ML model-based system as one or more of:
a one-to-one correlation, wherein a single attribute from the existing ML model-based system correlates to a single attribute of the upgraded ML model-based system;
a one-to-many correlation, wherein a single attribute from the existing ML model-based system correlates to a plurality of attributes of the upgraded ML model-based system;
a many-to-one correlation, wherein a plurality of attributes from the existing ML model-based system correlates to a single attribute of the upgraded ML model-based system;
a correlation of a continuous changing attribute;
a negative correlation of an attribute between the existing ML model-based system and the upgraded ML model-based system; or
a non-correlated attribute between the existing ML model-based system and the upgraded ML model-based system.

19. The non-transitory computer-readable storage medium of claim 18, wherein generating the extended set of features is further based on the identified correlation of the one or more key features between the existing ML model-based system and the upgraded ML model-based system.

20. The non-transitory computer-readable storage medium of claim 17, wherein the extended set of features further includes one or more closest correlated features, the closest correlated features representing features in the upgraded ML model-based system that are most closely related to attributes that are present in the existing ML model-based system and are absent from the upgraded ML model-based system.
